(19) United States
(12) Patent Application Publication
(10) Pub. No.: US 2015/0112759 A1
(43) Pub. Date: Apr. 23, 2015

(54) METHOD AND APPARATUS FOR PROVIDING CUSTOMIZED FOOD LIFE SERVICE

(71) Applicant: SAMSUNG ELECTRONICS CO., LTD., Suwon-si (KR)

(72) Inventors: Soon-hyuk HONG, Suwon-si (KR); Woo-shik KANG, Suwon-si (KR); Jung-wook KIM, Suwon-si (KR); Nikolay BULRUTSKIY, Suwon-si (KR); Seung-young SHIN, Seoul (KR); Kyung-eun LEE, Suwon-si (KR)

(21) Appl. No.: 14/516,138

(22) Filed: Oct. 16, 2014

(30) Foreign Application Priority Data
Oct. 21, 2013 (KR) 10-2013-0125256

(51) Int. Cl. G06F 17/30; G06Q 30/02; G06Q 30/06; G10L 15/00

(52) U.S. Cl. CPC G06F 17/30; G10L 15/00; G06Q 30/0201; G06Q 30/0631; G06Q 30/0633
USPC 705/7.29; 235/375; 704/246; 705/26.7

(57) ABSTRACT

A method and apparatus for providing a customized food life service is provided. The method includes: sensing a wireless frequency identification tag attached to food to receive data; processing and storing the received data; analyzing and modeling the stored data; and providing food management information based on the analyzing and modeling result.

### CROSS-REFERENCE TO RELATED APPLICATIONS

This application claims priority under 35 U.S.C. §119 from Korean Patent Application No. 10-2013-0125256, filed on Oct. 21, 2013, in the Korean Intellectual Property Office, the disclosure of which is incorporated herein by reference in its entirety.

### BACKGROUND

1. Field

The present disclosure relates to providing a technology for providing a customized food life service, to providing a technology for providing a food life service using a radio frequency identification (RFID) technology.

2. Description of the Related Art

Home electronic appliances and user devices that apply information technology (IT) such as the Internet or the like have been quickly made smart, and various intelligent services have been possible. Also, as radio frequency identification (RFID) and sensor network technologies are developed, it is easy to collect various types of information of user devices, and there is a need to provide a user-customized service by using the various types of information. As the user devices have high functions and are made smart, easiness of using the user devices becomes important. For this, a natural user interaction (NUI) technology has been developed.

However, if RFID is attached to food to manage the food in the home, the food may be very conveniently managed, and information about such management is required to be provided to a user through a refrigerator or the like.

In particular, an existing food life service focuses on management of a list of food and/or food materials, etc. by using an RFID technology on a refrigerator system. Therefore, there is a need to provide a customized service in consideration of a food life pattern of a user.

### SUMMARY

Additional aspects and/or advantages will be set forth in part in the description which follows and, in part, will be apparent from the description, or may be learned by practice of the invention.

Exemplary embodiments address at least the above problems and/or disadvantages and other disadvantages not described above. Also, the exemplary embodiments are not required to overcome the disadvantages described above, and an exemplary embodiment may not overcome any of the problems described above.

The exemplary embodiments provide a method and apparatus for providing a customized food life service, by which a radio frequency identification (RFID) tagging method for food in a smart refrigerator is provided by using the smart refrigerator and a smartphone to perform tracking with respect to the food, tracking of recipe searches and recipe selections of a user is performed in the smart refrigerator or the smartphone to check a food life pattern of the user, and user-customized services such as management, purchase, cooking, etc. of food are provided based on the food life pattern of the user.

According to an aspect of the exemplary embodiments, there is provided a method of providing a customized food life service. The method may include: sensing a wireless frequency identification tag attached to food to receive data; processing and storing the received data; analyzing and modeling the stored data; and providing food management information based on the analyzing and modeling result.

The method may further include: providing food purchase recommendation information based on the analyzing and modeling result.

The method may further include: providing recipe recommendation information based on the analyzing and modeling result.

The wireless frequency identification tag may be a radio frequency identification (RFID) tag.

The method may further include: collecting a user voice. The processing and storing of the received data may include recognizing the collected user voice to tag and store the collected user voice on the received data.

The modeling of the stored data may include analyzing the stored data to model purchase and consumption patterns of food and/or food materials.

The providing of the food management information may include providing at least one of information about whether the food and/or food materials exists and expiration date information of the food and/or food materials.

The providing of the food purchase recommendation information may include providing a shopping list based on the analyzing and modeling result.

The method may further include: collecting an uttered voice of the user; recognizing the collected uttered voice of the user; searching the stored data for information about food and/or food materials corresponding to the recognized uttered voice of the user; and providing the searched information about the food and/or food materials.

The method may further include: receiving a user input through a user interface; searching the stored data for information of food and/or food materials corresponding to the received user input; and providing the searched information of the food and/or food materials.

According to one aspect of the exemplary embodiments, there is provided an apparatus for providing a customized food life service. The apparatus may include: a display unit; an antenna unit configured to sense a wireless frequency identification tag attached to food in order to receive data; a storage unit configured to process and store the received data; and a controller configured to control the display unit to analyze and model the stored data and display food management information based on the analyzing and modeling result.

The controller may control the display unit to display food purchase recommendation information based on the analyzing and modeling result.

The controller may control the display unit to recipe recommendation information based on the analyzing and modeling result.

The wireless frequency identification tag may be an RFID tag.

The apparatus may further include a voice collector configured to collect a user voice. The controller may recognize the collected user voice to tag and store the collected user voice on the received data.

The controller may analyze the stored data to model purchase and consumption patterns of food and/or food materials.

The controller may control the display unit to display at least one of information about whether food and/or food materials exists and expiration date information of the food and/or food materials.

The controller may control the display unit to display a shopping list based on the analyzing and modeling result.

The apparatus may further include a voice collector configured to collect an uttered voice of a user. The controller may control the display unit to recognize the collected uttered voice of the user, search the stored data for information of food and/or food materials corresponding to the recognized uttered voice of the user, and display the searched information of the food and/or food materials.

The apparatus may further include a user input unit configured to receive a user input through a user interface. The controller may control the display unit to search the stored data for information of food and/or food materials corresponding to the received user input and display the searched information of the food and/or food materials.

According to various exemplary embodiments as described above, a method and apparatus of tagging an RFID on food in a smart refrigerator by using the smart refrigerator and a smartphone to track the food. Also, searches of a user for a recipe and selections of the user of the recipe may be tracked in the smart refrigerator or the smartphone to check a food life pattern of the user. A user-customized service such as management, purchase, cooking, etc. of food may be provided based on the food life pattern of the user.

### BRIEF DESCRIPTION OF THE DRAWINGS

The above and/or other aspects will be more apparent by describing certain exemplary embodiments with reference to the accompanying drawings, in which:

FIG. 1 is a view illustrating a system for providing a customized food life service, according to an exemplary embodiment;

FIG. 2 is a brief block diagram illustrating a structure of an apparatus for providing a customized food life service, according to an exemplary embodiment;

FIG. 3 is a block diagram illustrating a structure of an apparatus for providing a customized food life service, according to one exemplary embodiment;

FIG. 4 is a view illustrating a process of attaching radio frequency identification (RFID) tags to purchased food and/or food materials and then putting the RFID tags into a refrigerator;

FIG. 5 is a flowchart illustrating a method of providing a customized food life service according to an exemplary embodiment;

FIG. 6 is a flowchart illustrating zero step tagging according to an exemplary embodiment;

FIG. 7 is a flowchart illustrating one step tagging according to an exemplary embodiment;

FIG. 8 is a flowchart illustrating three step tagging according to an exemplary embodiment;

FIG. 9 is a flowchart illustrating three step tagging, according to another exemplary embodiment;

FIG. 10 is a block diagram of a preprocessor, according to an exemplary embodiment;

FIG. 11 is a block diagram illustrating a structure of a data informationizing unit, according to an exemplary embodiment;

FIG. 12 is a table illustrating a data structure for managing food and/food materials, according to an exemplary embodiment;

FIG. 13 is a block diagram illustrating a structure of a data collector, according to an exemplary embodiment;

FIG. 14 is a view illustrating a user food life pattern-based shopping helper service, according to an exemplary embodiment;

FIG. 15 is a view illustrating a personalized recipe search service that is based on a user food life model, according to an exemplary embodiment;

FIG. 16 is a block diagram illustrating a structure of a controller, according to an exemplary embodiment;

FIG. 17 is a view illustrating a process of tagging information about purchased food and/or food materials through inputting of a voice of a user, according to an exemplary embodiment;

FIG. 18 is a view illustrating a process of searching for stored food and/or food materials with a voice, according to an exemplary embodiment;

FIG. 19 is a view illustrating a process of searching for a recipe with a voice, according to an exemplary embodiment; and

FIG. 20 is a view illustrating a process of executing a refrigerator menu function based on a voice, according to an exemplary embodiment.

### DETAILED DESCRIPTION

Exemplary embodiments are described in greater detail with reference to the accompanying drawings.

In the following description, the same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

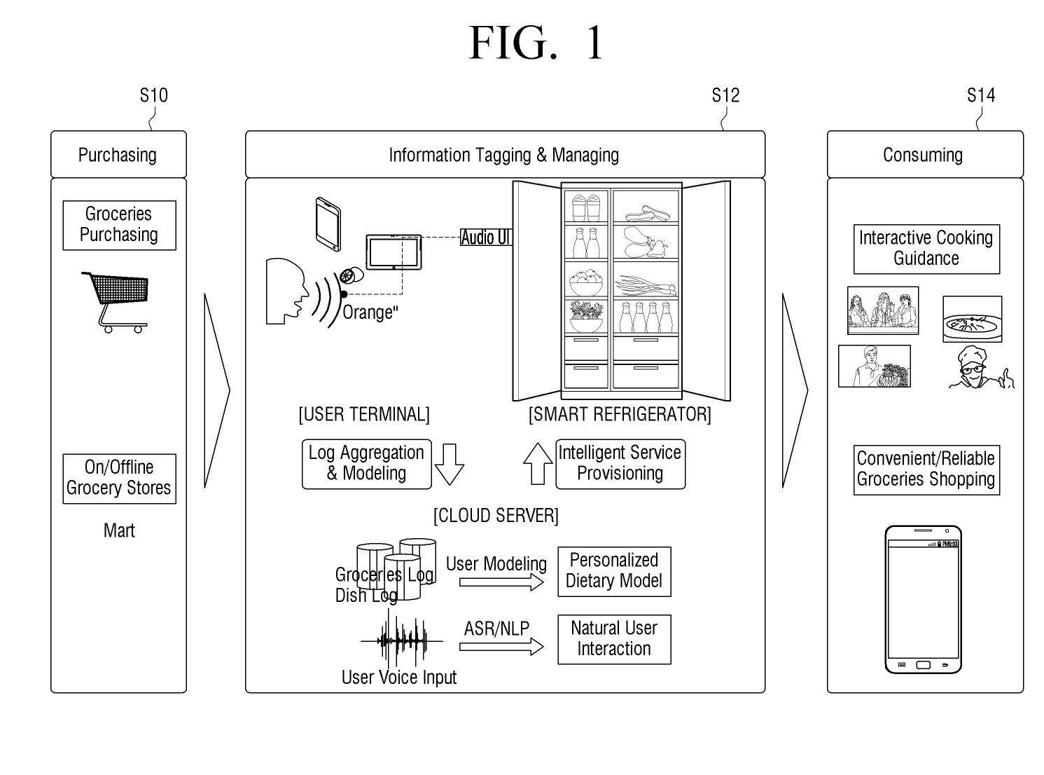

FIG. 1 is a view illustrating a system for providing a customized food life service, according to an exemplary embodiment.

Referring to FIG. 1, a method of providing a customized food life service includes purchase operation S10, information tagging and managing operation S12, and consuming operation S14. The purchasing operation S10 refers to an operation in which a user purchases food and/or food materials on line or at an offline store. A user terminal such as a personal computer (PC), a smartphone, or the like may be used to purchase the food and/or food materials. The information tagging and managing operation S12 is a process of tagging and managing information about food and/or food materials purchased by a user terminal such as a smartphone, a tablet PC, or the like, a smart refrigerator, a cloud server, or the like. The consuming operation S14 is a service execution operation that consumes food and/or food materials purchased by a user or uses food and/or food materials-related information provided by the system.

In the system as shown in FIG. 1, the smart refrigerator and the user terminal may include radio frequency identification (RFID) sensing, voice inputs/outputs, touch screen inputs, and various types of sensors and tag the food and/food materials purchased by the user on various levels. The tagged food and/or food materials may be tracked by the system of the present embodiment. In other words, information about when, where, what, and how much food and/food materials are purchased, how and how much the food and/food materials are consumed in the system, how much the food and/food materials are left in the present, and how long the food and/food materials will be consumed, etc. may be managed, and the tracked information may be stored as groceries log. Also, if the user performs a search in relation to a food life or uses information besides tracking of the food and/or food materials, the user may track the search or the using of the information.

For example, information about a recipe search and/or selection, information about cooking directly done by the user, etc. may be tracked by the system and then collected as a dish log.

The collected information about the food and/or food materials and information related to the food life of the user (recipe search and/or selection, etc.) are used and modeled as information for analyzing a food life pattern of the user. The modeled food life pattern of the user is used to provide a user-customized service such as an interactive cooking guide, a food and/or food materials shopping service, etc.

Also, the system may analyze a voice input of the user to tag information about food and/or food materials, select a system service required by the user, and respond to the system service.

A structure and an operation of an apparatus 100 for providing a customized food life service according to an exemplary embodiment of the present general inventive concept will now be described in detail.

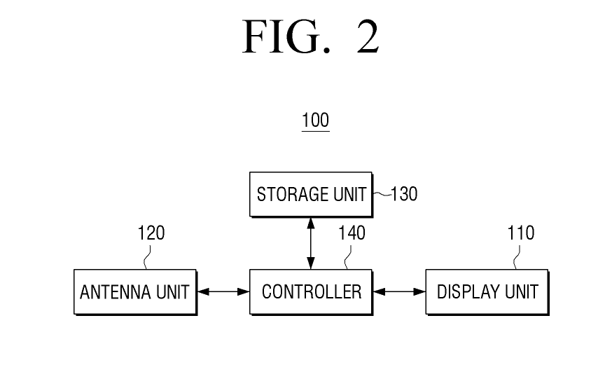

FIG. 2 is a brief block diagram illustrating the structure of the apparatus 100 for providing the customized food life service, according to an exemplary embodiment.

The apparatus 100 may be, for example, a refrigerator or any home appliance, but is not limited thereto. Also, several apparatuses may commonly perform a function of the apparatus 100. In other words, an external server may store, analyze, and model data, and the refrigerator may perform only a display. Also, if the apparatus 100 is connected to a terminal apparatus through a communicator, the terminal apparatus may provide a user interface (UI) such as a display.

Referring to FIG. 2, the apparatus 100 includes a display unit 110, an antenna unit 120, a storage unit 130, and a controller 140.

The display unit 110 is an element that displays information and provides a UI. The display unit 110 may be positioned outside the apparatus 100, display various types of information, and include a liquid crystal display (LCD) and a touch panel.

The antenna unit 120 respectively emits a frequency to a wireless frequency identification tag attached to food or food materials according to a preset frequency at preset time intervals. The wireless frequency identification tag responds to a frequency to transmit stored data to the antenna unit 120. The antenna unit 120 transmits received data to a reader (not shown), and the reader analyzes and processes the data.

Here, the wireless frequency identification tag may be one of a read only tag, a write one read many (WORM) tag, and a read/write tag. Also, the wireless frequency identification tag may be realized as one of an active tag including power, a passive tag not including power, and a semi-passive tag that includes a battery and uses a back scattering modulation method like the passive tag.

The wireless frequency identification tag may be an RFID tag.

The storage unit 130 processes and stores the received data. The storage unit 130 stores information of the wireless frequency identification tag attached to the food or the food materials. The information includes food and/food material information. The storage unit 130 also stores user food life modeling information, which is analyzed and modeled by the apparatus 100, a word dictionary necessary for voice recognizing/natural language processing of a user voice input, modeling information, etc. in a database (DB). Also, the storage unit 130 stores a rule, a pattern, etc. that is referred to when selecting an action that is to be performed with respect to a user input.

The storage unit 130 may be realized as various types of technical units. For example, the storage unit 130 may include a memory such as a read only memory (ROM) or a random access memory (RAM), a hard disk drive (HDD), etc. In particular, the storage unit 130 may be established as a DB to store massive data or may be managed as an additional server.

A method of realizing a DB is not limited. In other words, the DB may be one of a hierarchical database (HDB), a relational database (RDB), and an object-oriented database (OODB). If a DB is established in an additional server, the DB may be realized as a network database (NDB) besides the above-mentioned types of DBs.

The controller 140 controls an overall operation of the apparatus 100. In particular, the controller 140 controls the display unit 110 to analyze and model the stored data and display food management information based on the analyzing and modeling results.

The controller 140 may also control the display unit 110 to display food purchase recommendation information based the analyzing and modeling results.

The controller 140 may control the display unit 110 to display recipe recommendation information based on the analyzing and modeling results.

The apparatus 100 may further include a voice collector (not shown) that collects user voices. Voice collection may be performed by a general microphone. For example, the voice collection may be performed by at least one of a dynamic microphone, a condenser microphone, a piezoelectric microphone using a piezoelectric phenomenon, a carbon microphone using contact resistances of carbon particles, a (omnidirectional) pressure microphone that generates an output proportional to an acoustic pressure, and a bidirectional microphone that an outputs proportional to a negative particle speed.

The controller 140 may control the storage unit 130 to recognize the collected user voice, tag the recognized user voice on the received data, and store the tagged data. Text information corresponding to a voice of the user may be generated by using a speech to text (STT) engine to perform voice recognition. The STT engine is a module that converts a voice signal into a text by using various types of existing STT algorithms.

For example, the STT engine detects a start and an end of a voice uttered by a speaker in a voice of the speaker to determine a voice section. In detail, the STT engine may calculate energy of a received voice signal, classifies energy levels of the voice signal according to the calculated energy, and detect a voice section through dynamic programming. The STT engine may detect a phoneme, which is a minimum unit of a voice, in the detected voice section based on an acoustic model to generate phoneme data and apply a hidden markov model (HMM) probability model to the generated phoneme data to convert the voice of the speaker into the text.

The STT engine extracts a feature of the voice of the speaker from the collected voice. The feature of the voice refers to a feature that includes information such as a tone, an accent, a pitch, etc. of the speaker and by that a listener identifies through a voice. The feature of the voice is extracted from a frequency of the collected voice. Examples of a parameter expressing the feature of the voice include energy, a zero crossing rate (ZCR), a pitch, a formant, etc. As a voice feature extracting method for voice recognition, a linear predictive coding (LPC) method of modeling a vocal tract of a person and a filter bank method of modeling an auditory organ of a person are widely used. An analysis method in a time domain is used, and thus computation is small. Also, a very high recognition performance shows in a silent environment, but a recognition performance is remarkably lowered in a noisy environment. A method of modeling an auditory organ of a person with a filter bank is mainly used as an analysis method for recognizing a voice in a noisy environment. Also, a mel-frequency cepstral coefficient (MFCC) based on a mel-scale filter bank is mainly used as a voice feature extracting method. According to a psychoacoustics research, a relation between a pitch of a physical frequency and a pitch of a subjective frequency is not linear. Therefore, Mel that defines a frequency scale subjectively felt by a human separately a physical frequency f expressed with Hz is used.

The controller 140 may analyze the stored data to model purchases and consumption patterns of food and/or food materials.

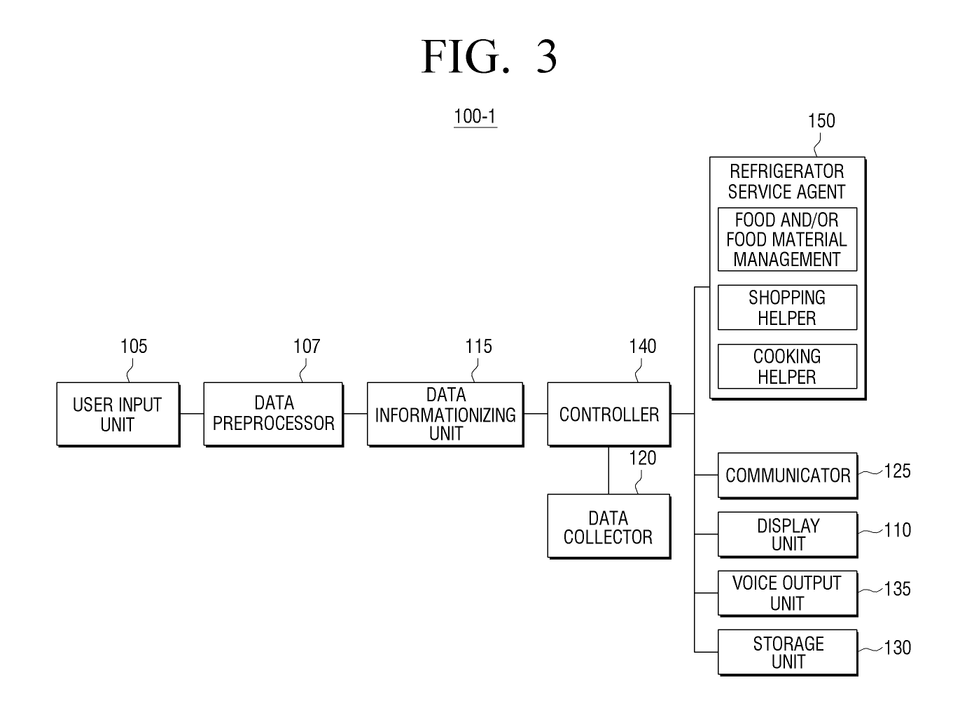

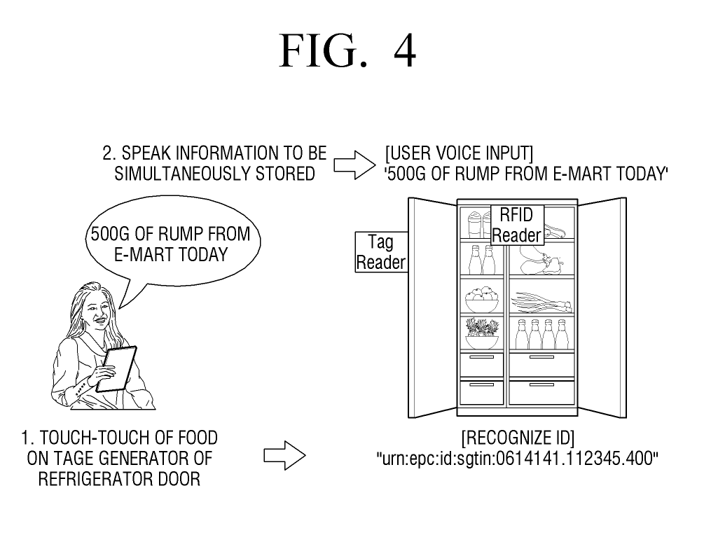

FIG. 3 is a block diagram illustrating a structure of an apparatus 100-1 for providing a customized food life service, according to another exemplary embodiment t. FIG. 4 is a view illustrating a process of attaching an RFID tag to purchased food and/or food materials and putting the food and/food material into a refrigerator by a user.

A user input unit 105 senses inputs, events, etc. from a microphone, an LCD touch screen display, an RFID reader, sensor, etc. of a smart device, i.e., a smartphone, a tablet PC, or a smart refrigerator. Also, a user input may include input information of a microphone, an LCD touch screen, a sensor, etc. of another smart device or a user terminal apparatus connected through a network. When the user puts purchased food and/or food materials, the user input unit 105 inputs information about the purchased food and/or food materials into a system through a tagging method including various operations.

FIG. 4 illustrates a process of attaching an RFID tag to purchased food and/or food materials and putting the food and/or food materials by a user. Here, the user may input additional information about the purchased food and/or food materials into the system with a voice. In more detail, if the user takes the food and/or food materials with the RFID tag to an RFID recognition antenna installed on an outer surface of the refrigerator, an ID of the RFID tag attached to the food may be recognized, and a beep sound for informing the user of whether the ID of the RFID tag is recognized may be generated to allow the user to perform a voice input.

A data preprocessor 107 and a data informationizing unit 115 may process the user voice and the recognition of the ID of the RFID tag. Preprocessing of the user voice requires a voice data extraction, a noise removal, etc., and a sentence conversion and natural language processing of a voice are performed through automatic voice recognition for informationizing. Also, whether the ID of the RFID tag corresponds to a particular ID rule is pre-checked to recognize the ID of the RFID tag.

A controller 140 applies and/or analyzes a rule based on informationized user input sentence information to determine a function and a service that the user requires and thus selects an action that will be performed by the system. As shown in FIG. 3, the controller 140 controls a refrigerator service agent to automatically select and perform a food and/or food material management, shopping helper, a cooking helper. Also, the controller 140 controls the system to perform a display or a voice output in order to transmit a response to the user.

A data collector 120 collects actions of the user, i.e., an action for putting or taking food and/or food materials into and/or out of the refrigerator, a controls or an information input history performed by the user with a voice, search and/or performance histories for a recipe in the refrigerator, etc., models a food life of the user based on the collected actions, and analyzes a user preference, a consumption pattern, etc. with respect to the food and/or food materials.

A storage unit 130 stores food and/or food material information tagged by the user, user food life modeling information analyzed and modeled by the system, a word dictionary and modeling information necessary for voice recognition and/or natural language processing of a user voice input, etc. in a DB. The storage unit 130 also stores a rule, a pattern, etc. that is referred to when the system selects an action to be performed with respect to a user input, in the DB. The storage unit 130 may be realized as a DB of a refrigerator single system or a large-scale DB on a cloud server.

A communicator 125 communicates with an external apparatus to operate along with the external apparatus when dispersing and performing some functions, etc. in a server or a cloud server according to a function configuration of a refrigerator system and operating an external service (for example, a recipe server) along with the refrigerator system. The communicator 125 includes a unit that transmits inventory information, cooking information, etc. to a portable terminal apparatus when requesting the inventory information, the cooking information, etc.

A display unit 110 displays a system response on the refrigerator system or an additional user terminal (a smartphone or the like).

A voice output unit 135 outputs a system output of a user input as a voice message such as TTS or the like.

The function configuration of FIG. 3 is aimed at the apparatus 100-1 of FIG. 3, and thus respective function modules may be distributed or respectively mounted on a smart refrigerator, a user terminal, and a cloud server. For example, a user input such as a voice input, a touch, or the like and a system output such as an LCD, a voice output, or the like may be simultaneously constituted on the smart refrigerator and the user terminal. Functions of the data informationizing unit 115 and the controller 140 may be mounted between the smart refrigerator and the cloud server in a distribution way. To constitute and/or maintain the storage unit 130, a DB of a system may be copied into the smart refrigerator and the cloud server.

A method of providing a customized food life service by using an apparatus for providing a customized food life service will now be described.

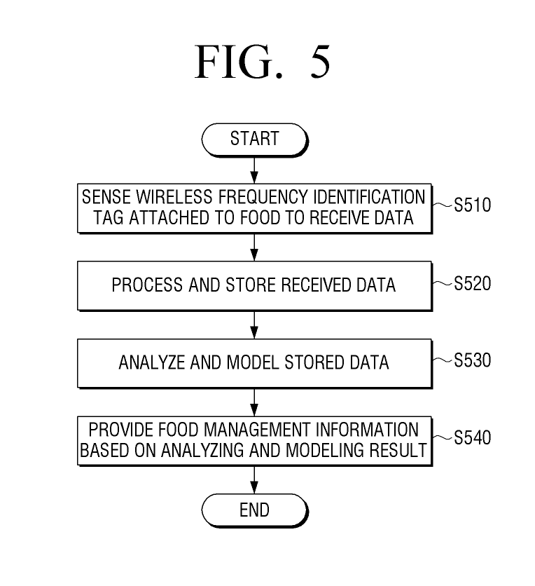

FIG. 5 is a flowchart illustrating a method of providing a customized food life service, according to an exemplary embodiment.

Referring to FIG. 5, in operation S510, a wireless frequency identification tag attached to food is sensed to receive data. In operation S520, the received data is processed and stored. In operation S530, the stored data is analyzed and modeled. In operation S540, food management information is provided based on the analyzing and modeling result.

The method may further include providing food purchase recommendation information based on the analyzing and modeling result.

The method may further include providing recipe recommendation information based on the analyzing and modeling result.

The method may further include collecting a user voice. The processing and storing of the received data may include recognizing the collected user voice, tagging the user voice on the receive data, and storing the user voice.

The above-description operations will now be described in more detail.

1) Tagging Information on Purchased Food and/or Food Materials.

Information about food and/food materials purchased by a user may be input and/or collected and managed to track purchasing, managing, and consuming operations of the food and/or food materials. In the present general inventive concept, for this, various levels of information tagging methods are provided by using various types of information input interfaces of the user input unit 105 described with reference to FIG. 3. As described with reference to FIG. 3, an RFID tag interface, a user voice input interface, a touch screen input interface, various types of sensor interfaces (a camera, an infrared approach sensor, etc.), an input interface of another smart device connected through a network, etc. may be used as information input interfaces that may be used by the user input unit 105. In other words, an apparatus for providing a customized food life service according to the present general inventive concept may provide information tagging including various operations by using at least one of various types of user input interfaces as described above.

A) RFID Tag

A system has an RFID tag recognition function to tag information on the food and/or food materials purchased by the user. In the present general inventive concept, an RFID tag may be a food and/or food material provider defining RFID tag attached in distribution operations of a producer, a distributor, a seller, etc. of food and/food materials or a user RFID tag including food and/food materials provided along with an apparatus for providing a customized food life service according to the present general inventive concept.

The food and/or food material provider defining RFID tag is defined as an RFID tag ID defined by a provider, and corresponding food and/or food materials are provided from the provider to register and manage the food and/food material information in the system.

Differently from the food and/food material provider defining RFID tag, the user RFID tag provided with the apparatus is allocated an RFID tag ID pre-defined in the system, and pre-defined food and/food material information of the corresponding ID is also provided on the system.

The user RFID tag is used when an RFID tag is not attached to purchased food and/food materials, the food and/or food materials is re-packed by the user, or the food is food that is directly cooked by the user. The user RFID tag may be formed in a shape of food and/or food materials, or an image food and/or food materials may be printed on a surface of the RFID tag. In other words, the user may identify a food and/food material category by using only the shape or the image of the RFID tag to easily attach the RFID tag to the corresponding food and/or food materials. Also, a tag ID of a category classified according to a food and/food materials shape or image of a corresponding tag is pre-allocated.

B) Step-by-Step Tagging Method

Information tagging about food and/food materials having various steps is possible by using several types of information input methods such as an RFID tag, a user voice, etc. There may be four methods of zero step tagging, one step tagging, two step tagging, and four step tagging.

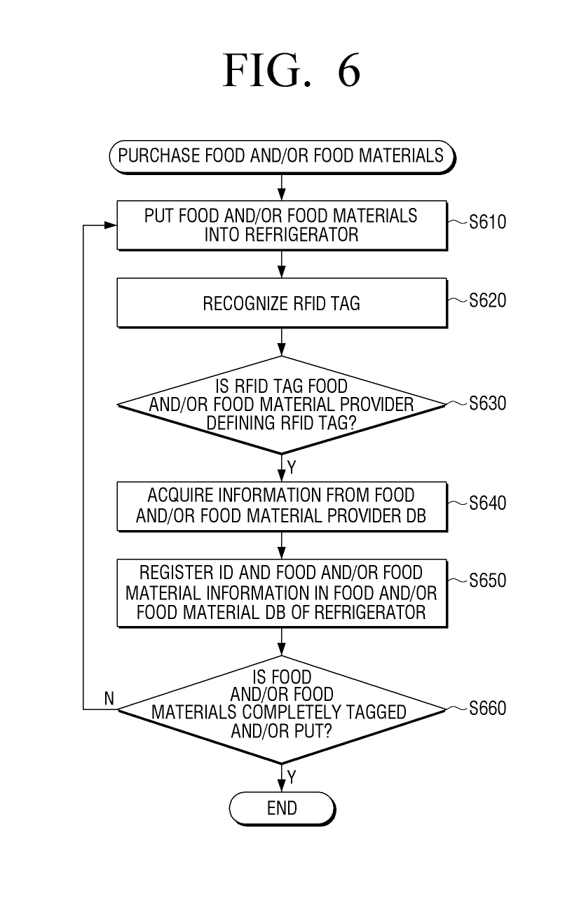

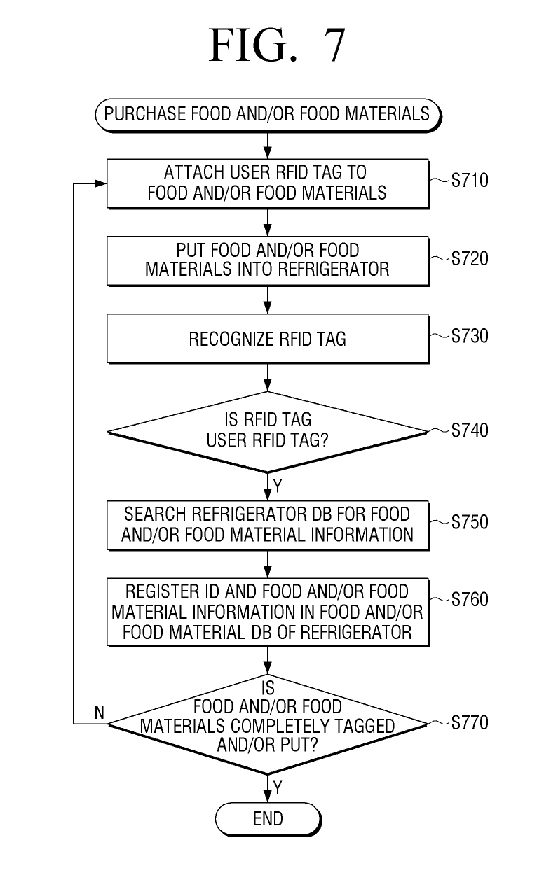

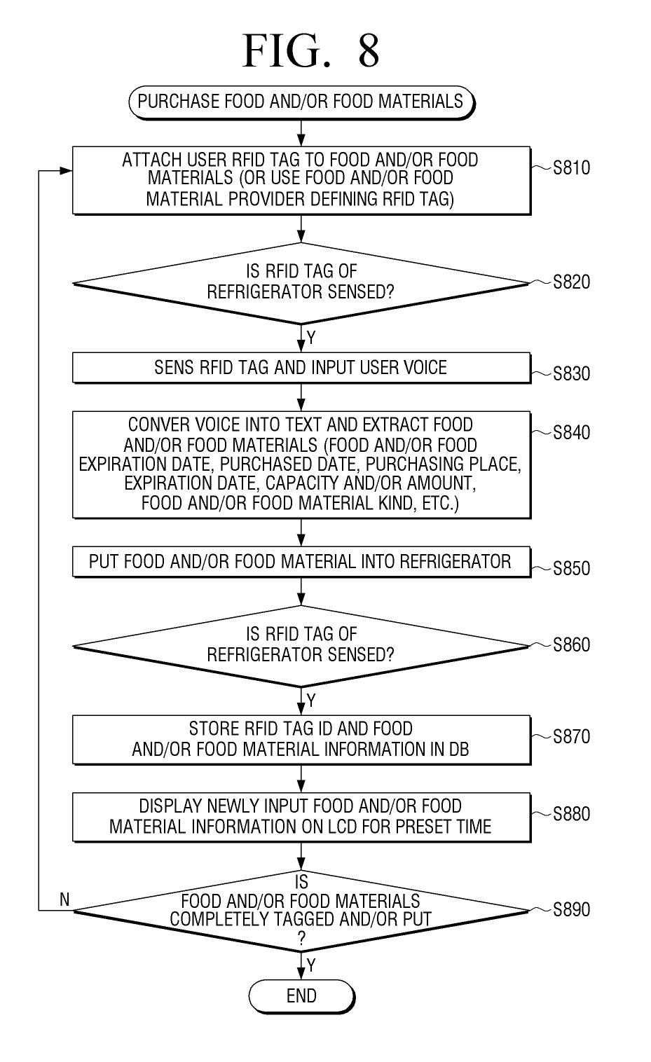

FIG. 6 is a flowchart illustrating zero step tagging according to an exemplary embodiment. FIG. 7 is a flowchart illustrating one step tagging according to an exemplary embodiment. FIG. 8 is a flowchart illustrating three step tagging according to an exemplary embodiment.

\textcircled{1} Zero Step Tagging

If a user has an RFID tag that is pre-attached by a food and/or food material provider (producer/distributor/seller), the user immediately puts purchased food and/or food materials into a refrigerator without an additional tagging process, and a refrigerator system may read and manage these information.

Referring to FIG. 6, when performing the zero step tagging, the refrigerator system shows a process of recognizing an RFID tag to register information. According to the zero step tagging, the food and/food material provider (producer/distributor/seller) attaches an RFID tag to a corresponding product to provide product information. Therefore, in operation S610, the user puts food and/food materials into the refrigerator. In operation S620, an RFID reader installed in the refrigerator recognizes an RFID tag of the corresponding food and/food materials. In operation S630, an apparatus for providing a customized food life service determines whether the recognized RFID tag is a user RFID tag provided along with the apparatus or a tag attached by the food and/or food materials provider (producer/distributor/seller). Since the recognized RFID tag is the tag attached by the food and/or food materials provider (producer/distributor/seller) when performing the zero step tagging, the refrigerator system uses information provided by the food and/food materials provider (producer/distributor/seller) as food and/food material information corresponding to an ID of the recognized RFID tag in operation S640. In operation S650, the food and/or food material information of the corresponding food and/or food materials provider (producer/distributor/seller) is stored along with the ID of the corresponding RFID tag in a food and/food material DB of the refrigerator system. Here, the food and/or food material DB of the refrigerator system may be copied into a cloud server or the like to be stored in a food and/or food material DB of the cloud server.

\textcircled{2} One Step Tagging

A user RFID tag provided along with a refrigerator system is used. For example, the user RFID tag may be an image of food and/or food material is printed on a surface of food and/or food materials. Therefore, a user may check what kind of food is stored in a refrigerator with seeing only a tag image. The food and/food material image printed on the user RFID tag corresponds to a pre-defined food and/or food material category, and a category ID of the corresponding food and/or food material category is pre-stored. Therefore, the refrigerator system recognizes the user RFID tag attached to food and/food materials purchased by the user to manage the food and/or food materials.

FIG. 7 is a flowchart illustrating a process of recognizing an RFID tag to register information through a refrigerator system when performing one step tagging, according to an exemplary embodiment. The one step tagging is a method of directly attaching a user RFID tag to food and/food materials purchased by a user to tag information on the food and/or food materials. Here, the user RFID tag is an RFID tag having different images (an image may be printed or an RFID tag may vary according to food and/food material categories) of food and/or food material categories (for example, meat, vegetables, etc.) and is provided along with a refrigerator system. In operation S710, the user attaches the user RFID tag to purchased food and/or food materials. According to the one step tagging, after the user RFID tag is attached to the food and/food materials, the food and/or food materials is immediately put into the refrigerator without inputting additional information in operation S720. In operation S730, an RFID reader installed in the refrigerator recognizes an RFID tag attached to the food and/or food materials. In operation S740, whether the recognized RFID tag is the user RFID tag is checked. In operation S750, the refrigerator system acquires information about a kind of food and/or food material from an ID of the corresponding RFID tag. Therefore, the refrigerator acquires food and/food material information from a DB of the refrigerator. In operation S760, the ID of the RFID tag and the food and/or food material information are registered in the DB.

\textcircled{3} Two Step Tagging

Two step tagging is a method of recognizing an RFID tag and tagging more detailed information on food and/or food materials with a voice by a user. For this, an RFID reader antenna may be included besides a refrigerator. To tagging information on food and/food materials with a voice of the user, the user takes food and/or food materials with an RFID tag to the RFID reader antenna to sense the food and/or food materials through the RFID reader antenna, the RFID tag is recognized, and thus a beep sound is generated. Therefore, the user vocalizes food information with a voice in response to the beep sound. An apparatus for providing a customized food life service receives a user voice input to extract food information, maps the extracted food information on an ID of the recognized RFID tag, and stores the food information in a food and/or food material DB of the refrigerator system. Here, even if orders of a tag recognition and a user voice information input are reversed, the refrigerator system may map the food information on the ID of the recognized RFID tag. In other words, although the user vocalizes voice information before a beep sound is output when recognizing the RFID tag, the refrigerator system determines that the voice information is user voice information about corresponding food and/or food materials and maps the voice information.

FIG. 8 is a flowchart illustrating a process of recognizing an RFID tag to register information through a refrigerator system when performing two step tagging, according to an exemplary embodiment. Like when performing the one step tagging, when performing the two step tagging, a user RFID tag is attached on purchased food and/or food materials in operation S810. Alternatively, a food and/or food material provider (producer/distributor/seller) may use food and/or food materials to which an RFID tag is attached. Information about the food and/or food materials may be additionally input through a user voice input.

If an RFID reader antenna installed on a refrigerator recognizes the RFID tag as described above in operation S820, the user performs a voice input in operation S830. For example, the user may input additional information about the purchased food and/or food materials like “100 g of beef from TESCO today” with a voice. In operation S840, the apparatus for providing the customized food life service converts the user voice input into a text sentence and extracts food and/food material information, i.e., a name of food and/food materials, a purchase date, a purchase place, an expiration date, capacity and/or amount, a kind of the food and/or food materials, etc., from the input information.

If the user puts the food and/or food materials with the RFID tag into the refrigerator in operation S850, an RFID reader of the refrigerator recognizes the RFID tag in operation S860. In operation S870, the apparatus stores an ID of the recognized RFID tag and the food and/food material information input through a user voice in a food and/or food material DB of the refrigerator. Here, if the RFID tag is a food and/or food material provider defining RFID tag, food information of a food and/or food material provider (producer/distributor/seller) may be used. If the RFID tag is a user RFID tag attached by the user, food and/or food material information pre-defined by the ID of the RFID tag may be used. Items of the food information of the food and/or food material provider (producer/distributor/seller) and food and/or food material information pre-defined in a user RFID tag are updated by voice input information of the user. In other words, the voice input information of the user takes priority over the food information of the food and/or food material provider (producer/distributor/seller) and information of an image tag.

In operation S880, the apparatus outputs registered food and/or food material information registered on an LCD for a preset time so that the user checks registered contents.

\textcircled{3} Three Step Tagging

In comparison with the two step tagging, the three step tagging further includes a process of outputting contents of put items to a user on a touch screen display to allow the user to check registered contents and correct the registered contents by using a touch screen input when registering and putting purchased food and/or food materials into a refrigerator.

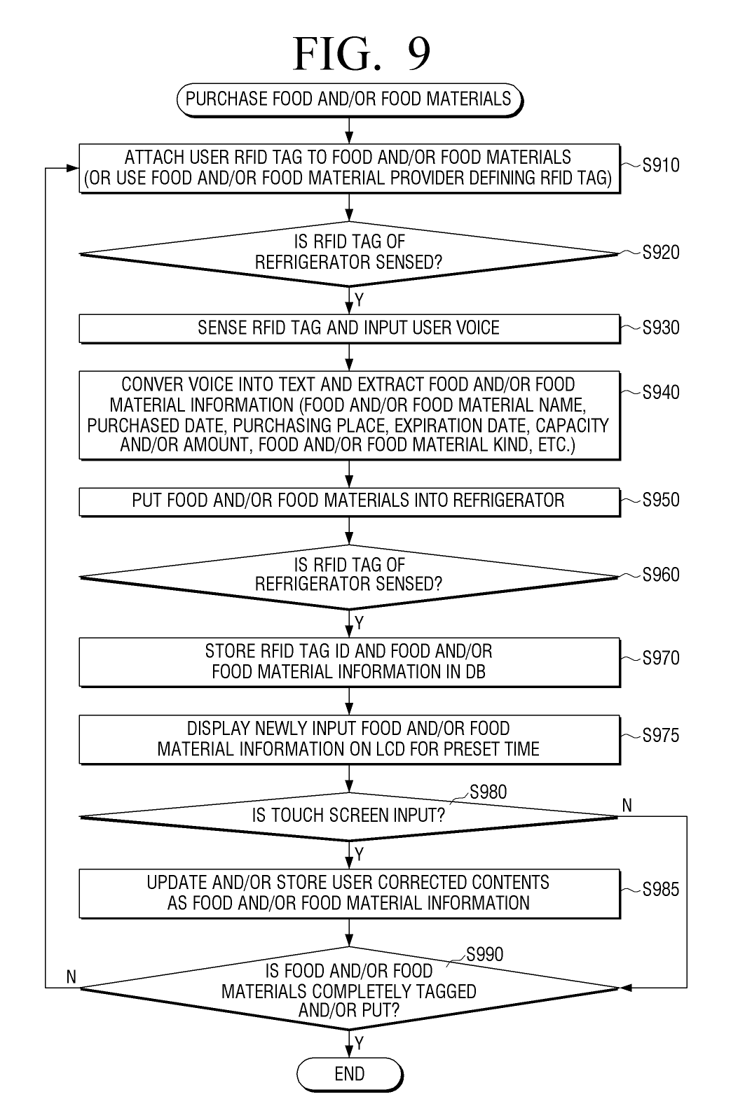

FIG. 9 is a flowchart illustrating three step tagging according to another exemplary embodiment.

FIG. 9 illustrates a process of similar three step tagging to the three step tagging of FIG. 8. The process further includes operations S980 and 985 of recognizing an RFID tag and automatically registering user voice information and then checking and correcting automatically registered food and/or food material information output on a touch screen by a user. If there is an input on the touch screen, a refrigerator system contents corrected and/or added by the user as food and/or food material information and stores the food and/or food material information in a food and/or food material EB.

C. Processing Data for Information Tagging

In order to tag information on purchased food and/or food materials, input data is processed as information that is to be managed in a system. In other words, data input from the user input unit 105 of FIG. 3 is tagged as information on the purchased food and/or food materials through a data preprocessor and a data informationizing unit.

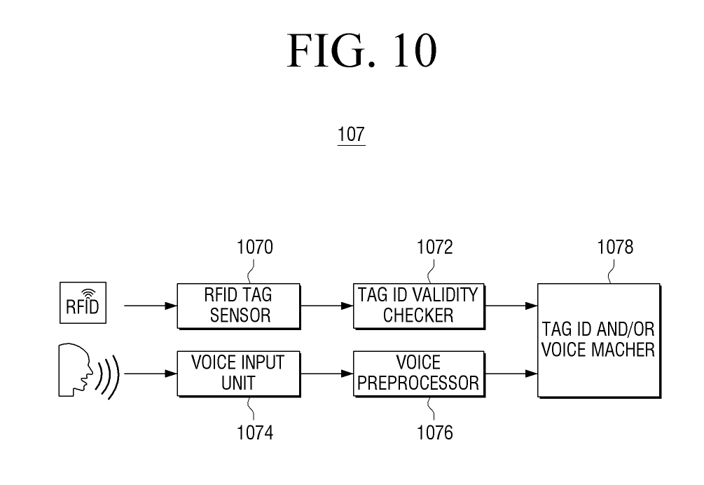

FIG. 10 is a block diagram of the data preprocessor 107, according to an exemplary embodiment.

FIG. 10 illustrates a structure of the data preprocessor 107 that performs two step tagging, i.e., attaches an RFID tag to purchased food and/or food materials by a user and inputs additional information through a voice input of the user. If the user puts the food and/or food materials with the RFID tag onto an RFID tag sensor 1070, an RFID reader of FIG. 10 senses the RFID tag. If then, the RFID reader extracts an RFID tag ID from the sensed RFID tag, and a tag ID validity checker 1072 checks validity of the RFID tag ID. Also, a beep sound from which a tag will be sensed may be output. Here, the user may input additional information about the food and/or food material with a voice through a microphone that is a voice input unit 1074. Here, a voice preprocessor 1076 recognizes a part corresponding to a voice uttered by the user from an acoustic signal of the microphone (i.e., performs end point detection) and stores the part as a file. The voice preprocessor 1076 includes a noise reduction function of reducing background noise that is recorded together when the user utters the voice. A tag ID/voice matcher 1078 determines whether the sensed RFID tag ID and the user voice input are data about the same food and/or food materials, in consideration of an input timing of the data and matches the RFID tag ID and a voice file. Therefore, even if the user voice input is performed before recognizing the RFID tag, the system matches the RFID tag and the user voice input to correctly perform information input.

In zero step tagging and one step tagging, an RFID reader of a refrigerator directly senses a tag, and preprocessing functions such as the RFID tag sensor 1070 and the RFID tag ID validity checker 1072 are performed according to the method described with reference to FIG. 10.

If the RFID tag ID and the user voice file match each other in the data preprocessor 107, the data informationizing unit 115 analyzes the user voice file to informationize a user intention and included data.

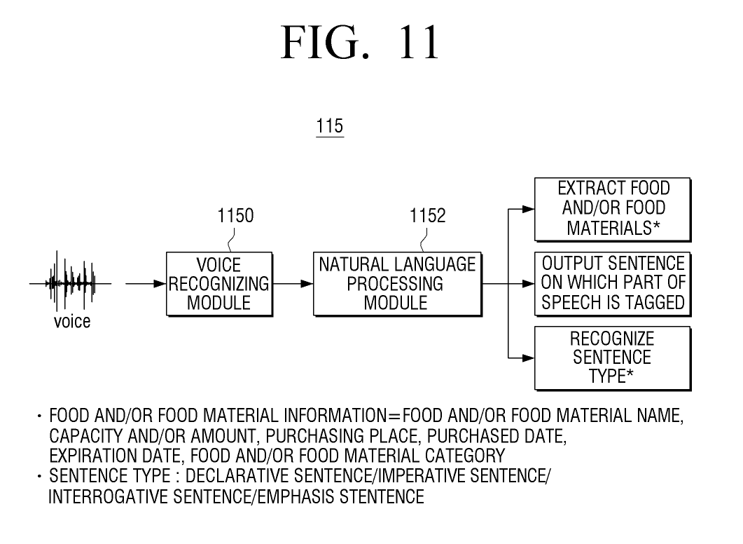

FIG. 11 is a block diagram illustrating a structure of the data informationizing unit 115, according to an exemplary embodiment.

Referring to FIG. 11, the data informationizing unit 115 is a module that analyzes user voice information to interactively perform questions and answers between a user and an apparatus. The data informationizing unit 115 may include a voice recognizing module 1150, a natural language processing module 1152, a part of speed dictionary, a named entity (food/food material, place, etc.) dictionary, a sentence structure, a particular vocabulary pattern DB, etc. The voice recognizing module 1150 converts a user voice into a text sentence, and the natural language processing module 1152 analyzes the text sentence to detect part of speech information of each word and extracts major food and/food material information from the part of speech information. In other words, the natural language processing module 1152 may include all software (SW) modules that analyze a text sentence. Since this function requires a large number of DBs and processing of the DBs, a natural language processing module may be mounted and processed to establish, process, and analyze the DBs on a cloud server. A named entity extractor may extract information about food and/or food materials from the text sentence. For example, if the user inputs “beef from TESCO today” with a voice when attaching an RFID tag to food and/or food materials and putting the food and/or food materials into a refrigerator, a system converts the voice of the user into a text sentence like “beef from TESCO today” through a voice recognition. Part of speed of each word is determined by using part of speech information dictionary. For example, a sentence on which parts of speech are tagged may be acquired like “beef (noun), TESCO (pronoun), today (adverb)”. If then, a part of speech of food and/or food materials is noun or pronoun, and thus named entity candidates of beef (noun) and TESCO (pronoun) may be detected from the corresponding sentence. If the beef (noun) is a word that is registered in a food and/or food material dictionary, the beef (noun) may be recognized and output as a major named entity. Also, if TESCO (pronoun) is registered in a place dictionary, TESCO (pronoun) may be recognized as a named entity of a purchasing place. Examples of information that may be input with voices by user in relation to food and/or food materials purchased by the user may include a food and/or food material name, capacity and/or amount, a purchasing place, a purchasing date, an expiration date, a food and/or food material category, etc. The food and/or food material name, the purchasing place, etc. may be analyzed by a named entity extracting method, and the capacity and/or amount, the purchasing date, the expiration date, etc. may be analyzed by pattern matching of corresponding phrase and/or word.

Also, the natural language processing module 1152 may check a sentence type of the input text sentence. In other words, the natural language processing module 1152 may analyze a sentence structure to recognize and output whether a sentence is a declarative sentence, an imperative sentence, an interrogative sentence, an exclamatory sentence, or the like.

As in the data informationizing unit 115 of FIG. 11, three results, food and/food material information extracting, part of speed-tagged sentence outputting, sentence type recognizing, are acquired through the natural language processing module 1152.

For example, if the user utters “200 g of beef from TESCO today” with a voice, an input sentence is analyzed to determine a part of speech of each word through the voice recognizing module 1150 and the natural language processing module 1152 of FIG. 11. In other words, parts of speeches of respective words are tagged like “200 g (numeral+noun) of (preposition) beef (noun) from (preposition) TESCO (pronoun) today (adverb)”. Food and/food material information is extracted from the sentence. In other words, “food and/or food material name=beef”, “capacity and/or amount=200 g”, “purchasing place=TESCO”, “purchasing date=today”, “expiration date=none”, and “food and/food material category=mean” may be extracted as food and/food material information. Also, a type of the sentence may be regarded as a declarative sentence in which a subject and a verb are omitted. Therefore, the system may control to perform a necessary function by using results of the data informationizing unit 115 as described above.

1) A Method of Tracking User Food Life Act

If the user tags information about purchased food and/or food materials, the apparatus for providing the customized food life service may manage food and/or food materials in the system according to RFID tag IDs. In other words, the apparatus may track information about what kind of food and/food materials are stored in the refrigerator, what kind of food and/or food materials are put into and/or taken out of the refrigerator, what kind of food and/or food materials are frequently consumed for a preset time, etc. As a result, the user tracks a series of processes of purchasing, managing, and consuming food and/or food materials.

As a method of tracking a food life act of the user, putting and/or taking of food and/or food materials may be determined through RFID sensing.

A) Putting and/or Taking Food and/or Food Materials

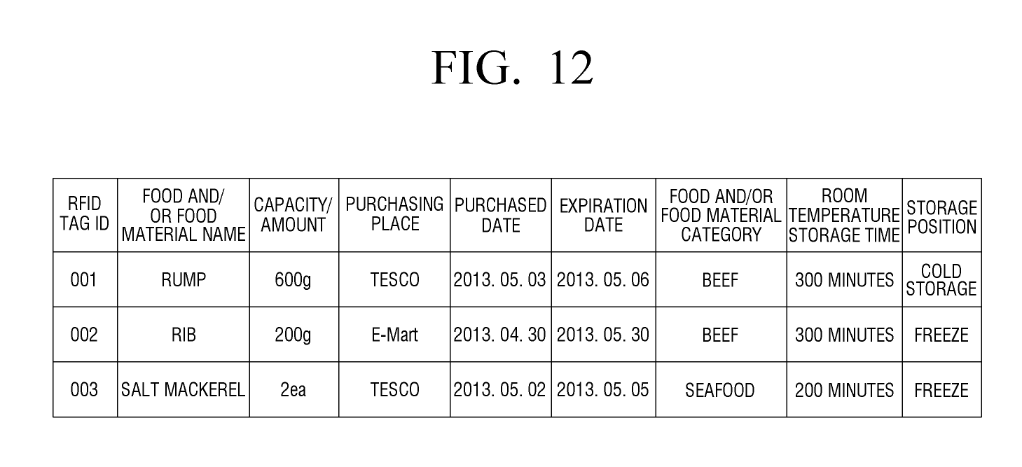

FIG. 12 is a table illustrating a data structure for managing food and/or food materials, according to an exemplary embodiment.

FIG. 12 illustrates a data structure for managing food and/or food materials stored in a system after tagging information about food and/or food materials. As shown in FIG. 12, the data structure may include an RFID tag ID, a food and/or food material name, capacity and/or amount, a purchasing place, a purchasing date, an expiration date, a food and/or food material category, a room temperature storage time, a storage position, etc.

Stored food and/or food materials may be respectively identified through RFID tag IDs. Each data of the corresponding RFID tag ID includes information of a user RFID tag, information of a food and/or food material provider, and information added by a user with a voice input or the like. Data directly input by the user has priority in the data structure. For example, information about an expiration date, a room temperature storage time, etc. of a corresponding RFID tag ID category may be acquired from category information pre-defined in a user RFID tag. However, if the user inputs information like “Orange juice should be good for 3 days.” with a voice or the like to include information about an expiration date when corresponding food and/or food materials are stored, expiration date data is updated as information input by the user.

After tagging and a data structure for managing food and/or food materials of an apparatus for providing a customized food life service are achieved, the apparatus may track when food is put and taken out, which food is put and taken out, etc. Since an RFID tag attached to food and/food materials is recognized, putting and/or taking food and/or food materials may be sensed to generate an event. For example, the apparatus may check that the user puts and/or takes out vegetables three times for three days or puts and/or takes out meat one time for a week. In other words, the apparatus may check when corresponding food and/or food materials are put, how often the food and/or food materials are put and/or taken out, and how long the food and/or food materials are stored and thus may analyze what kind of food is frequently consumed, etc.

Information about food and/or food material putting and/or taking acts as described above is used to model a user food life in a system.

B) Search for and Select Recipe

As another method of checking a user food life act, a recipe search application or the like may be used. In other words, a recipe searched by a user, a search word used by the user, a recipe actually selected by the user, etc. are collected as logs. For example, if the user searches for a recipe like “chicken pasta with hot taste” when a system provides a recipe search service, the apparatus may show chicken pasta with hot taste as a search result and the user may select a recipe of the search result to do cooking. Here, the apparatus may collect contents input by the user for searching, i.e., “chicken past with hot taste”, selected recipe information, i.e., a recipe name, main materials, etc., as information. If then, the apparatus may reflect the information on a user food preference or may use the information as information for modeling a food life.

3) Modeling of User Food Life

The apparatus may track a user food life act, and thus food life act logs may be collected to model and use a user food life. The data collector 120 of FIG. 3 collects and/or analyzes such user act logs to model a user food life.

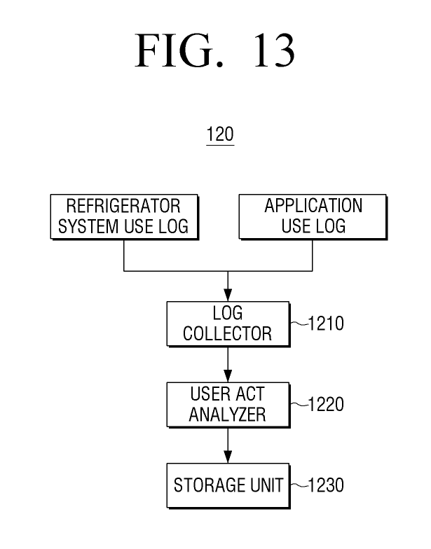

FIG. 13 is a block diagram illustrating a structure of the data collector 120, according to an exemplary embodiment.

Referring to FIG. 13, the data collector 120 may collect use logs of all acts of a user using a refrigerator system. For example, the data collector 120 may collect how often the user opens and/closes a door of a refrigerator, what kind of food the user puts into and/or takes out of the refrigerator, which voice the user inputs, which application the user executes, which data the user corrects, etc. In other words, a series of all user acts on the refrigerator system may be collected and/or used as logs. In relation to a food life management service, food and/or food material management, cooking helper, and shopping helper service performance logs, etc. may be collected as logs.

A log collector 1210 of FIG. 13 collects logs of uses of the refrigerator system and uses of a food life service-related application such as food and/or food material putting and/or taking, etc. A user act analyzer 1220 analyzes which act records used by the user may be recognized through the collected logs. For example, the user act analyzer 1220 analyzes a series of user acts performed for a preset time like the user opens the door of the refrigerator to take particular food and/or food materials and then puts the food and/or food materials after a preset time, etc. or generates meaningful data by using a method of detecting an event such as a particular act of a particular object (food and/or food materials) or the like. In other words, user modeling reflecting a tendency, a taste, a habit, etc. becomes possible by giving meaning to an act of the user. Meaningful data established as described above may be stored in the refrigerator or a storage unit of a cloud server to perform a user model data-based customized service when a particular service, for example, a recommendation service, is provided to the user. For example, if the user puts and/or takes a large amount of meat into and/or out of the refrigerator and searches a web for a recipe using meat materials several times, a preference level on meat is modeled as being high. Therefore, when the user searches for another recipe, for example, searches for pasta, the apparatus may first output a list of past recipes using meat as a main material to the user.

The user act analyzer 1220 classifies the collected logs according to several criterions. Preferences of the user are determined according to criterions such as a taste of food, food materials, a type of food, a district of food, etc. The taste of food is classified into a hot taste, a sweet taste, an acerbic taste, an astringent taste, etc., and the food materials are classified into vegetables, meat, fish and shellfish, etc. The type of food is classified into bread, rice, soup, cookie, source, etc., and the district of food is classified into American food, Chinese food, Korean food, Japanese food, etc. The user act analyzer 1220 calculates the preferences of the user of classification criterions and stores the preferences of the user in a DB. The log collector 1210 stores the logs according to time to analyze food preferences of the user according to time. The user act analyzer 1220 analyzes short-term and long-term preferences of season, morning/noon/evening, and food and/food materials through a user log according to time. For example, if a particular user much eat cabbage in a morning time, a recipe using cabbage is recommended as a next breakfast menu. Information about food preferred by the user in summertime, food preferred by the user in wintertime, etc. are classified to recommend recipes according to season. Also, a weight is more placed on a recipe recently preferred by the user more than on a recipe preferred by the user long time ago

To analyze a more expanded user act, various act logs, such as a plurality of user devices, an integrated online store, searches on a social network, dialogues, purchases, etc., may be analyzed and/or informationized to model a personal food life.

4) A Method of Providing User-Customized and/or Interactive Service

The present disclosure relates to a method of providing a user food life-customized service by using a smart refrigerator and a smartphone, by which a series of food life acts performed by a user through a system are tacked and modeled. A more personalized customized service may be provided to a user through an apparatus for providing a customized food life service. Also, an interactive service may be provided through a user voice input, and more personalized and/or intelligent services may be provided.

A) a Method of Providing a User Food Life Model-Based Customized Service

The system may provide a more customized service to the user through tracking and modeling of a user food life act as described above.

The apparatus may check a pattern in which particular food and/or food materials are periodically newly input and consumed for a preset time, through tracking putting and/or taking user food and/or food materials. For example, the apparatus senses an event in which a list of food and/or food materials is changed much at a time to check a periodical shopping propensity and may check what kinds of particular food and/or food materials, for example, milk, meat, fish, fruit, etc., the user purchases and how much the user purchases the particular food and/food materials. If the apparatus further analyzes a continuous purchasing pattern, the apparatus may check an item that is included in a purchase list each time and thus is to be included when doing shopping for food and/or food materials. Therefore, if a purchasing pattern of food and/or food materials is sensed, the system may periodically generate a shopping list and provide the shopping list to the user. Also, the system may generate the shopping list in consideration of a consumption cycle of each food and/or food materials.

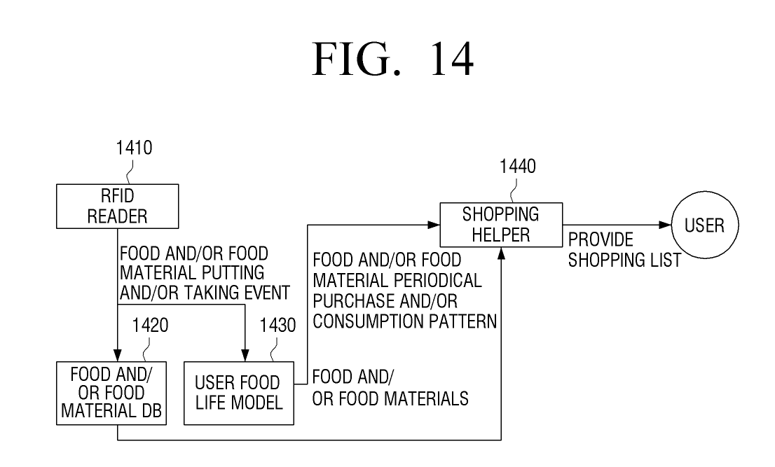

FIG. 14 is a view illustrating a shopping helper service that is based on a user food life pattern, according to an exemplary embodiment.

Referring to FIG. 14, an apparatus for providing a customized food life service may sense putting and/or taking of food and/or food materials through an RFID reader 1410. Putting and/taking events update a food and/or food material DB 1420 stored in the apparatus and analyze a series of putting and/or taking acts to establish a user food life model 1430. The user food life model 1430 may provide periodical purchase and/or consumption patterns of food and/or food materials that may be different according to food and/food materials. For example, milk products such as milk, etc. may be purchased every week, and peel fruit, etc. may be purchased every two-week, etc. In other words, the apparatus may differently check shopping cycles. Therefore, a shopping helper 1440 may use the periodical purchase and/or consumption patterns of food and/or food materials to provide a shopping list necessary for a user at a particular time. Here, the apparatus may refer to a food and/or food material DB 1420 thereof to check whether corresponding food and/or food materials is stored, an expiration of the food and/or food materials, etc. in order to provide the shopping list.

User food life modeling is used for a service that analyzes collected food life logs to extract preferences of the user for food and/or food materials.

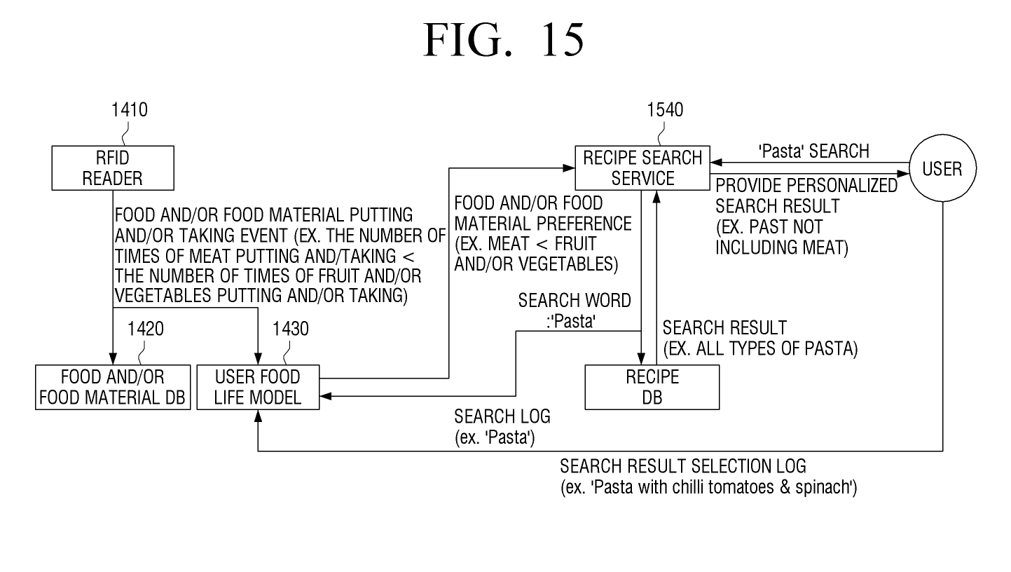

FIG. 15 is a view illustrating a personalized recipe search service that is based on a user food life model, according to an exemplary embodiment.

For example, the apparatus for providing the customized food life service may check information about put and/or taken food and/or food materials to further give preferences of the user to food and/or food materials if fruit and/or vegetables are frequently purchased and/or consumed more than meat. In this case, if a user searches for a recipe, for example, pasta, through a recipe search service 1540, the apparatus may acquire various types of pasta recipes as search results. Here, if the apparatus receives preference information of the user from the user food life model, the apparatus may recommend a pasta recipe with vegetables-oriented or fruit-oriented materials as a search result instead of a recipe with meat and output the recommended pasta recipe on a top of a result list. Therefore, the user may easily select a recipe that matches with preferences of the user.

As described above, an act of the user of searching for and/or selecting a particular recipe through a receipt search service is collected as a log to be used for establishing a user food life model.

B) A Method of Providing a User Voice-Based Interactive Service

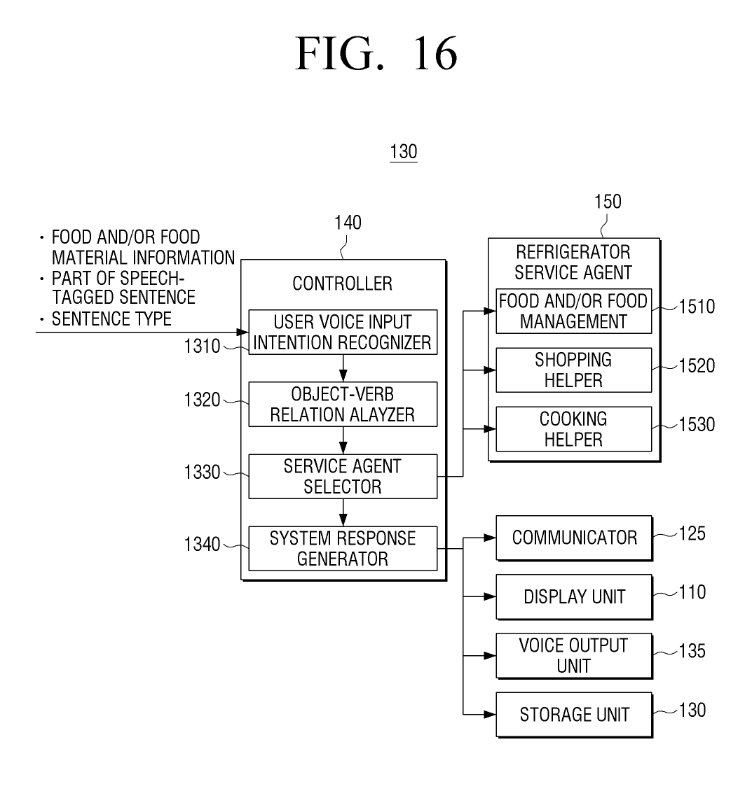

FIG. 16 is a block diagram illustrating a structure of the controller 140, according to an exemplary embodiment.

Referring to FIG. 16, the controller 140 is a module that controls the apparatus to select a refrigerator service agent 150 in order to perform a food life service providing service and generate a system response in order to interact with a user. An operation of the module may be performed on a server installed outside the refrigerator or may be performed by using a cloud that is a large-scale distributed processing system.

As shown in FIG. 16, the controller 140 includes a user voice input intention recognizer 1310, an object-verb relation analyzer 1320, a service agent selector 1330, and a system response generator 1340. The controller 140 receives inputs, such as food and/or food material information, a part of speech-tagged sentence, a sentence type, etc., that are results from the data informationizing unit 115 of FIG. 11 and controls a voice input intention check of the user and a system response based on informationized data.

The user voice input intention recognizer 1310 recognizes whether a user voice input intention is an information input, an information request, or a particular command, based on a type of a sentence input from the natural language processing module 1152 of the data informationizing unit 115. For example, if an input sentence type is a declarative type, a noun phrase, or an adverb phrase combination, and food and/or food material information input from the natural language processing module 1152 exists, a corresponding sentence is determined as a sentence for inputting information. If the input sentence type is an interrogative type, and a particular interrogative adverb (What, How, etc.) is used, the corresponding sentence may be determined as a sentence for requesting information. If the input sentence type is an imperative type or an emphasis type, the corresponding sentence is determined as a sentence for executing a particular command. These examples are used to define and determine a pattern or a rule in order to check voice input intentions of the user of various voice inputs of the user. The user voice input intention recognizer 1310 may refer to a sentence type and a word phrase tagged with a verb or an auxiliary verb in an input sentence in order to check a voice input intention of the user.

The object-verb relation analyzer 1320 checks whether an object is included in a particular category in an input sentence to set a relation between an object category and a verb. In other words, the object-verb relation analyzer 1320 may check whether the object is included in the input sentence and then check a set relation a principal verb and an object category exists. If contents exist in an object-main principal relation DB, the object-verb relation analyzer 1320 may select a function or a service that is to be performed by a system through a voice input of the user. For example, an object-verb relation may be set to food type-find, food type-search, food name-show, refrigerator's function-run, or the like. For this, a dictionary including food types, food material names, refrigerator function names, etc. may be required. In other words, objects may be categorized to establish dictionaries of the objects. As examples of these dictionaries, object dictionaries of food types (pasta, bulgogi, beef-rib stew, etc.), food material names (daikon, Chinese cabbage, red-pepper source, etc.), refrigerator's functions (groceries manager, cooking agent, shopping agent, etc.), etc. may be used.

A service agent selector 1330 matches a user voice input intention check result and the object-verb relation with a pre-defined rule DB to selects a performable service agent. For example, if conditions are satisfied by a pre-defined rule, the service agent selector 1330 may select a particular service agent. For this, a pre-defined service agent rule DB is required.

### Example 1

if (user input sentence type==declarative type) and (object-verb relation [symbol] ==food type-buy) and if (food/food material information exists) then Invoke ‘food/food material management’ service agent selection

### Example 2

if (user input sentence type==interrogative type) and (interrogative adverb==‘how’) and (object-verb relation==‘food type-′make’) then Invoke ‘cooking helper’ service agent selection with ‘Recipe search’ operation request

When calling a service agent, particular service information and additional information that are to be executed by the corresponding service agent may be transmitted as in example 2 above. For example, as in example 2 above, if a user input sentence like “How to make the hot chicken pasta?” is input, a user input sentence type is an interrogative type, and “How” is used as an interrogative adverb. Also, a principal verb is “make”, and an object is “the hot chicken past” that is a food type. Therefore, the controller 140 may call a cooking helper service agent as a service agent that is to be performed by a pre-defined rule. Also, a recipe search function may be performed, and search object information, i.e., “the hot chicken pasta” herein, may be additionally transmitted to the corresponding cooking helper service agent.

Several service agents may be constituted on a refrigerator. For example, a food and/or food material management service agent, a shopping helper service agent, a cooling helper service agent, etc. may be constituted.

A food and/or food material management service agent 1510 manages food and/or food materials that are put into and/or taken out of the refrigerator by using a food management application. The food and/or food material management service agent 1510 checks food putting and/or taking, manages a list of food and/or food materials and expiration dates, etc. based on RFID sensing.

A shopping helper service agent 1520 may periodically generate a shopping list for purchasing food and/or food materials according to a request of the user by using a food and/or food material shopping application.

A cooking helper service agent 1530 interacts with the user and informs the user of recipe contents when doing cooking or searches for a recipe according to a request of the user. Also, the cooking helper service agent 1530 may recommend a user-customized recipe based on food life information of the user when searching for a recipe.

A system response generator 1340 may perform a particular service and/or function through a service agent and output text to speech (TTS), a text, etc. to respond to the user. For example, if a service agent selection fails according to an analysis result of a user voice input, the system response generator 1340 may output a corresponding notice phrase or the like as TTS or a text. As shown in FIG. 16, the system response generator 1340 operates along with a system response communicator 125, a display unit 110, a voice output unit 135, a storage unit 130, etc. For example, the communicator 125 may perform a particular operation on an external cloud server or the system or may request contents of a particular DB. If a recipe that the user wants to search for does not exist on the apparatus, the apparatus may acquire a search result from an external recipe server to search for the corresponding recipe. If a voice input intention of the user is a food and/or food material information input, the apparatus may store new information in the storage unit 130 of the apparatus. According to a structure of the apparatus, information about food and/or food materials in the refrigerator may be copied into and stored on a storage unit of the external cloud server through the communicator 125.

Various types of services may be provided by using the operation of the controller 140 of FIG. 16. For example, voice-based food and/or food material information tagging, food and/or food material searches, recipe searches, system function controls, etc. may be provided.

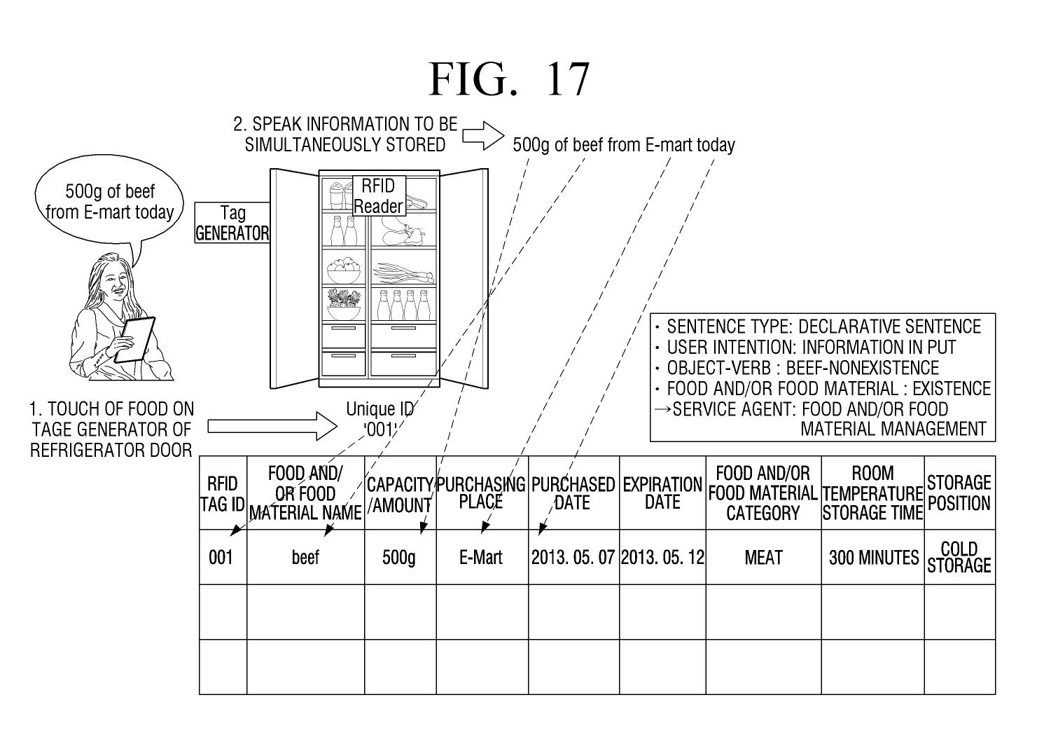

FIG. 17 is a view illustrating a process of tagging information on purchased food and/or food materials through a voice input of a user, according to an exemplary embodiment.

For example, if the user inputs “500 g of beef from E-mart today” with a voice, the system analyzes an input sentence according to the operation of the controller 140 of FIG. 16. In other words, a sentence type is analyzed as a declarative sentence, a user intention is analyzed as an information input, an object-verb relation is analyzed that beef does not exist, food and/or food materials are analyzed that the food and/or food materials does not exist. Therefore, a necessary service agent may be selected, and thus a food and/or food material service agent may be selected. As a result, food and/or food materials in a user input sentence may be input into a DB as in an example of a food and/or food material data structure of FIG. 12. In other words, in the user input sentence, a food and/or food material name may be input as beef, capacity and/or amount may be input as 500 g, a purchase place may be input as E-mart, a purchased date may be input as today (ex. 2013. 05. 07.). Here, an RFID tag ID may be input together.

Food and/or food material stored in the apparatus may also be searched for.

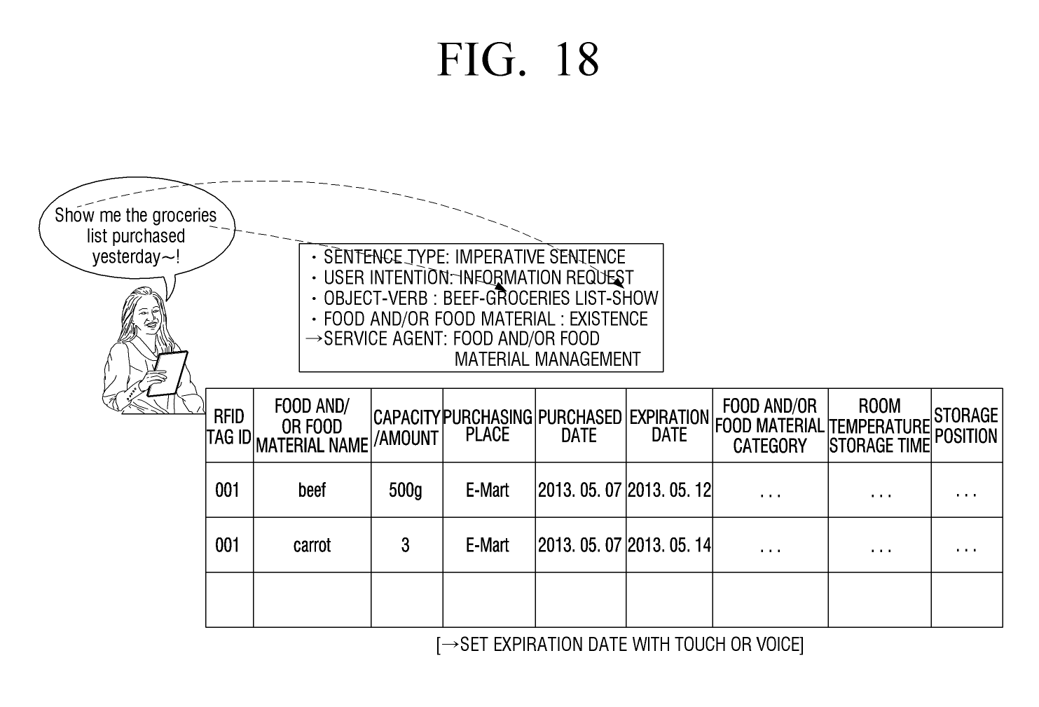

FIG. 18 is a view illustrating a process of searching for stored food and/or food materials with a voice, according to an exemplary embodiment.

For example, if a user inputs “Show me the groceries list purchased yesterday˜!”, the apparatus may analyze that a sentence type is an imperative type, and a user intention is an information request. Also, since an object-verb relation is groceries list-show relation, a food and/or food material management service agent may be selected as a necessary service agent. A system may search a list of food and/or food materials stored in a refrigerator for an item that matches with conditions and output the item.

As another example, a recipe search may be performed with a voice.

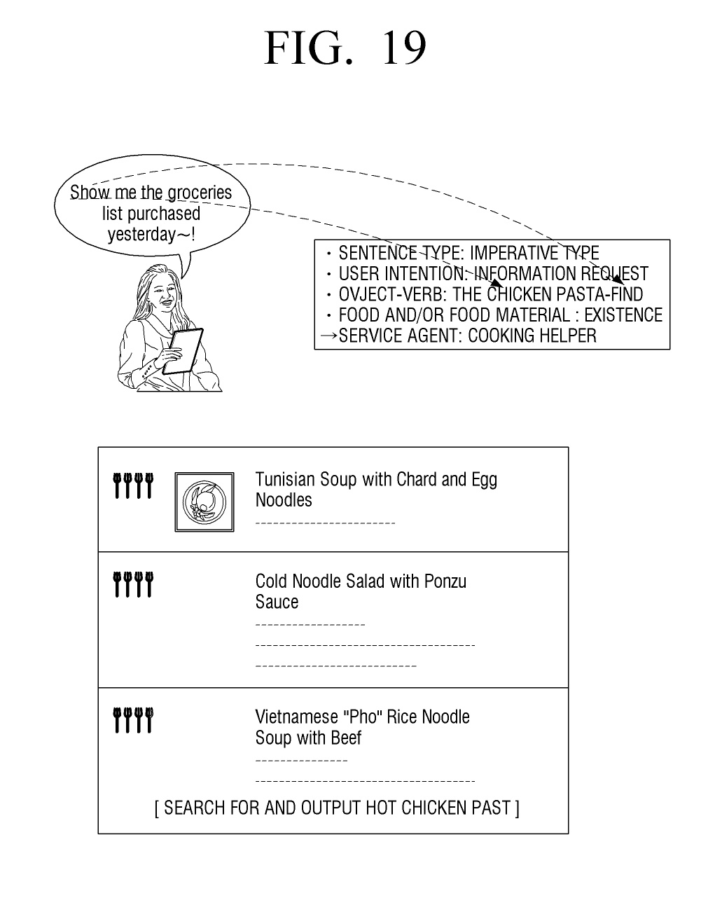

FIG. 19 is a view illustrating a recipe search that is performed with a voice, according to an exemplary embodiment.

For example, if a user inputs “Find the chicken pasta with hot taste˜!”, a system may check that a sentence type is an imperative type, and a user intention is an information request. Also, since an object-verb relation is “the chicken past-find”, the object-verb relation is a search for food. Therefore, the system may select and/or execute a cooking helper service agent according to a corresponding user input, search for hot chicken past according to a user request, and output the search result.

The user may execute a particular function of a refrigerator system with a voice. A refrigerator system that includes an existing LCD touch screen forms a graphical user interface (GUI) or the like that may be input through a touch by the user on an LCD to execute a refrigerator function. However, when the user uses a particular function, a user touch input including several steps may be necessary. In this case, an execution of a function through a voice input may be useful.

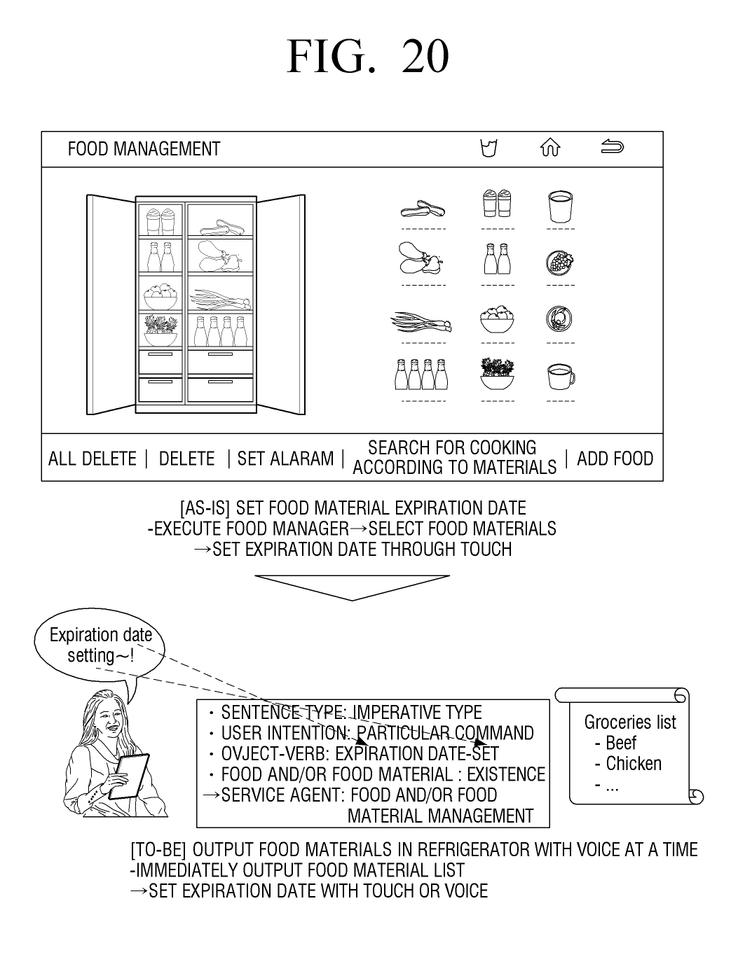

FIG. 20 is a view illustrating a process of executing a refrigerator menu function that is based on a voice, according to an exemplary embodiment.

For example, if a user inputs “Expiration date setting˜!”, the apparatus may analyze this to check that a sentence type is an imperative type, a user intention is a particular command execution, and an object-verb relation is expiration date-set. Here, if the apparatus has a dictionary command set of “Expiration date setting”, the apparatus may immediately execute a corresponding command. Therefore, more intuitive and faster execution is possible than an input for setting a food and/food material expiration date in a system through an existing LCD touch screen input method.

According to various exemplary embodiments as described above, various levels of user tagging may be provided to induce a new function and/or service use. Also, food and/or food materials in a refrigerator system may be managed through food and/or food material tagging to reduce inefficient food purchasing and consuming. In addition, a user food life model may be established to provide a person-customized service and perform a service based on a user voice.

The foregoing exemplary embodiments and advantages are merely exemplary and are not to be construed as limiting. The present disclosure can be readily applied to other types of apparatuses. Also, the description of the exemplary embodiments is intended to be illustrative, and not to limit the scope of the claims, and many alternatives, modifications, and variations will be apparent to those skilled in the art.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of providing a customized food life service, the method comprising:
sensing a wireless frequency identification tag attached to food to receive data;
processing and storing the received data;
analyzing and modeling the stored data; and
providing food management information based on the analyzing and modeling result.

2. The method of claim 1, further comprising:
providing food purchase recommendation information based on the analyzing and modeling result.

3. The method of claim 1, further comprising:
providing recipe recommendation information based on the analyzing and modeling result.

4. The method of claim 1, wherein the wireless frequency identification tag is a radio frequency identification (RFID) tag.

5. The method of claim 1, further comprising:
collecting a user voice,
wherein the processing and storing of the received data comprises recognizing the collected user voice to tag and store the collected user voice on the received data.

6. The method of claim 1, wherein the modeling of the stored data comprises analyzing the stored data to model purchase and consumption patterns of food and/or food materials.

7. The method of claim 1, wherein the providing of the food management information comprises providing at least one of information about whether the food and/or food materials exists and expiration date information of the food and/or food materials.

8. The method of claim 2, wherein the providing of the food purchase recommendation information comprises providing a shopping list based on the analyzing and modeling result.

9. The method of claim 1, further comprising:
collecting an uttered voice of the user;
recognizing the collected uttered voice of the user;
searching the stored data for information about food and/or food materials corresponding to the recognized uttered voice of the user; and
providing the searched information about the food and/or food materials.

10. The method of claim 1, further comprising:
receiving a user input through a user interface;
searching the stored data for information of food and/or food materials corresponding to the received user input; and
providing the searched information of the food and/or food materials.

11. An apparatus for providing a customized food life service, the apparatus comprising:
a display unit;
an antenna unit configured to sense a wireless frequency identification tag attached to food in order to receive data;
a storage unit configured to process and store the received data; and
a controller configured to control the display unit to analyze and model the stored data and display food management information based on the analyzing and modeling result.

12. The apparatus of claim 11, wherein the controller controls the display unit to display food purchase recommendation information based on the analyzing and modeling result.

13. The apparatus of claim 11, wherein the controller controls the display unit to recipe recommendation information based on the analyzing and modeling result.

14. The apparatus of claim 11, wherein the wireless frequency identification tag is an RFID tag.

15. The apparatus of claim 11, further comprising:
a voice collector configured to collect a user voice,
wherein the controller recognizes the collected user voice to tag and store the collected user voice on the received data.

16. The apparatus of claim 11, wherein the controller analyzes the stored data to model purchase and consumption patterns of food and/or food materials.

17. The apparatus of claim 11, wherein the controller controls the display unit to display at least one of information about whether food and/or food materials exists and expiration date information of the food and/or food materials.

18. The apparatus of claim 12, wherein the controller controls the display unit to display a shopping list based on the analyzing and modeling result.

19. The apparatus of claim 11, further comprising:
a voice collector configured to collect an uttered voice of a user,
wherein the controller controls the display unit to recognize the collected uttered voice of the user, search the stored data for information of food and/or food materials corresponding to the recognized uttered voice of the user, and display the searched information of the food and/or food materials.

20. The apparatus of claim 11, further comprising:
a user input unit configured to receive a user input through a user interface,
wherein the controller controls the display unit to search the stored data for information of food and/or food materials corresponding to the received user input and display the searched information of the food and/or food materials.

21. A home appliance, comprising:
a display;
a wireless frequency identification tag reader to read information on tag items;
a control unit that analysis the wireless frequency identification tags and displays at least one of a recipe based on the read items, the expiration of the items, storage length of the items, and/or consumption rate of the items.

22. The home appliance of claim 21, further comprising:
a user input that allows a user to enter item information correspond to the read wireless frequency identification tag.

23. The home appliance of claim 22, further comprising:
a storage unit configured to process and store the received information.
